(19) United States
(12) Patent Application Publication
(10) Pub. No.: US 2008/0023129 A1
(43) Pub. Date: Jan. 31, 2008

(54) Artificial decorative masonry and manufacturing process thereof

(76) Inventor: Bergevin Marcel, Repentigny (CA)

Correspondence Address: INVENTARIUM, suite 1607, 4050 Rosemont blvd, Montreal, QC, H1X 1M4, US

(21) Appl. No.: 11/486,563

(22) Filed: Jul. 15, 2006

(51) Int. Cl. B32B 37/12; B32B 38/04

(52) U.S. Cl. 156/245; 156/250; 156/297

(57) ABSTRACT

The present invention discloses an artificial piece of masonry such as, for example, bricks and stones, and its manufacturing method using specific ingredients combined and admixed in order to create a final product that can be easily cut without the need of special masonry saw blades. In fact the pieces thus produced can be cut using an ordinary knife, event blunt instruments, in order to facilitate installation even by a lay person or to make installation much faster for skilled workers. The process uses calcium sulfate already in solution as is commercially available.

This application is a continuation in part of patent application 2003017371210/378,782 filed Mar. 3, 2003

### BACKGROUND OF THE INVENTION

1. Field of the Invention

The invention relates generally to wall surfaces and most particularly to interior wall veneers that simulate bricks or natural stones.

2. Background of the Invention

Wall products for interiors, finished to reproduce the look of wood, brick or stone have been around for many years. They can be grouped into two groups: Firstly, wall panels, generally 4′×8′, with molded or simply printed representations of wood, brick, stone or other material. Secondly, wall products made of discrete components that are adhesively attached to a wall surface.

The prior art shows that various methods exist for making discrete artificial masonry pieces, molds and installation of the masonry on a surface, generally a wall.

Patents found in the prior art can be divided into three categories:

1) Those concerned with methods of laying precast or sectional components on surfaces such as in U.S. Pat. No. 3,690,076 by Harris and U.S. Pat. No. 4,727,698 by Altman for building fireplaces or U.S. Pat. No. 5,535,563 by Brown, which concerns itself with installing fitted manufactured stones to build decorative walls.

2) The second category concerns itself with making molds to create those artificial stones and bricks. A prime example of using molds is U.S. Pat. No. 5,637,236 by Lowe which discloses a method for producing wall, roadways, sidewalks and the like using cementitious material.

3) The third category is represented by U.S. Pat. No. 4,043,826 by Hum which discloses a process for making artificial rock.

This instant invention is mostly related to the prior art found in the second and third category. Generally, those products are designed with the handyman in mind and provide for a simple method of installation. Unfortunately, cutting masonry, whether real or cementitious is hard and requires special tools and skills. There is therefore a need for a masonry type product that provides discrete masonry pieces which are easy to cut with precision and install easily.

### Prior Art Capability and Motivations, as Helping to Show Patentability Here

Even in hindsight consideration of the present invention to determine its inventive and novel nature, it is not only conceded but emphasized that the prior art had many details usable in this invention, but only if the prior art had had the guidance of the present concepts of the present invention, details of both capability and motivation.

That is, it is emphasized that the prior art had/or knew several particulars which individually and accumulatively show the non-obviousness of this combination invention. E.g.,

(a) Calcium sulfate, perlite and pigments, have long been in worldwide use;

(b) The use of moulds to shape objects made out of plaster has also long been in worldwide use;

(c) The ease of assembly for the present invention has surely given manufacturers ample incentive to have made modifications for commercial competitiveness in a competitive industry, if the concepts had been obvious;

(d) The prior art has always had sufficient skill to make many types of toolings, moulds and features related, more than ample skill to have achieved the present invention, but only if the concepts and their combination had been conceived;

(e) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;

(f) The details of the present invention, when considered solely from the standpoint of production, are exceedingly simple, and the matter of simplicity has long been recognized as indicative of inventive creativity;

(g) Similarly, and a long-recognized indication of inventiveness of a novel combination, is the realistic principle that a person of ordinary skill in the art, as illustrated with respect to the claimed combination as differing in the stated respects from the prior art both as to assembly and concept, is presumed to be one who thinks along the line of conventional wisdom in the art and is not one who undertakes to innovate; and

(h) The predictable benefits from a novel piece of artificial masonry installation and procedure having the features of this invention would seem sufficiently high that others would have been working on this type of installation, but only if the concepts which it presents had been conceived.

(i) The invention currently benefits from strong sales in the marketplace which none of the prior art to which it has been compared with has achieved. Surely it would have been implemented by now if it had been so obvious given the need in the marketplace for such a product.

Accordingly, although the prior art has had capability and motivation, amply sufficient to presumably give incentive to the development of an installation and procedure according to the present invention, the prior art did not suggest this invention.

### Prior Art as Particular Instances of Failure to Provide this Novel Procedure and Installation

In view of the general economic and practical advantages of the present invention, it may be difficult to realize that the prior art has not conceived of the combination purpose and achievement of the present invention, even though all the elements are relatively common and widespread, both in the primary chemical elements as well as in mixing, moulding and curing process as well as the method of installation. Further, persons knowledgable with respect to masonry surely include an uncountable multitude of persons, at least of sufficient experience, skill, etc., that the present invention would have been desired and attempted long ago, but only if its factors and combination-nature had been obvious.

The consideration of the nature of the present invention concepts may be helped by a summarized consideration of the prior art as known to the inventor; however they are so well known and used, merely generalized reminders as to them as diverse and well-known prior art seem sufficient.

The present invention discloses an artificial piece of masonry such as, for example, bricks and stones, and its manufacturing method using specific ingredients combined and admixed in order to create a final product that can be easily cut without the need of special masonry saw blades. In fact the pieces thus produced can be cut using an ordinary knife, event blunt instruments, in order to facilitate installation even by a lay person or to make installation much faster for skilled workers. The process uses calcium sulfate already in solution as is commercially available.

That is, the use of calcium sulfate in the construction trade is known and surely could have been modified toward the present invention for many scores of years if the present improvement had been obvious.

### Summary of the Prior Art's Lack of Suggestions of the Concepts of the Invention's Combination

In spite of all such factors of the prior art knowledge and use, the problem here solved awaited this inventor's consideration, ideas, and creativity. More particularly, as to the novelty here of the invention as considered as a whole, a consideration of the prior art uses and needs helps show its contrast to the concepts, and emphasizes the advantages, novelty, and the inventive significance of the present concepts as are here shown, particularly as to utility and economy of use as detailed herein, as to procedure.

Moreover, prior art systems such as non-cement based products, which could possibly be adapted for this duty, fail to show or suggest the details of the present concepts as a combination; and a realistic consideration of the prior art's differences from the present concepts of the overall combination may more aptly be described as teaching away from the present invention's concepts, in contrast to suggesting them, even as to a hindsight attempt to perceive suggestions from a backward look into the prior art, especially since the prior art has long had much motivation as to details of the present invention and to its provisions.

And the existence of such prior art knowledge and related ideas embodying such various features is not only conceded, it is emphasized; for as to the novelty here of the combination, of of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of an economical apparatus achieving the economy and ease of use characteristics and other advantages of the present invention, which are goals only approached by the prior art, must be recognized as being a long-felt need.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

### Summary of Components and Operational Details, and Their Advantages

The present invention as detailed herein has advantages in both concept and in component parts and features; for in contrast to other systems known to the inventor as to the prior art mentioned, the invention provides advantageous features which should be considered, both as to their individual benefit, and to whatever may be considered to be also their synergistic benefit toward the invention as a whole. Such features and advantages include:

a) an artificial masonry piece cutable by scoring.

b) a method for manufacturing artificial masonry pieces.

c) a method for installing discrete masonry pieces.

d) a lightweight artificail masonry piece for use as a decorative covering.

e) a non-cementitious artificail masonry piece for use as a decorative covering.

In order to obtain the stated features and advantages, the invention generally comprises a portion of perlite admixed, by volume, with 7 portions of calcium sulfate (CaSO₄) in solution. The resulting mixture is stirred; pigments are added and the mixture is then poured into molds for curing.

In order to manufacture the product, the folowing method is used: One portion of perlite is admixed, by volume, with 7 portions of calcium sulfate (CaSO₄) in solution and a resulting mixture is stirred; pigments are added which are metal oxides; the mixture is poured into molds and set to cure.

In some embodiments, the curing process is preferably done at a temperature set at between 12 C to 25 C. Some embodiments have a curing process is preferably done at 17% relative humidity. Some embodiments have a 4 hour curing.

A variation of the manufacturing process involves extracting air bubbles from the resulting mixture after stirring is completed.

Yet another variation involves using one portion of perlite is admixed, by volume, with 7 portions of calcium sulfate (CaSO₄) in solution and a resulting mixture is stirred at a speed, of a range set between 60-100 RPM. The stirring taking between 8 to 12 minutes during which pigments are added which are generally metal oxides. The mixture is then poured into molds and set to cure.

In order to install the artificial masonry piece resulting from the method of fabrication as described hereiabove, an adhesive or bonding agent is applied onto a surface; masonry pieces are applied to the surface; the masonry pieces are cut by making a score line with a cutting means and the piece is cracked; joints are filled with mortar as is normally done for ordinary brick or stone construction.

### BRIEF DESCRIPTION OF THE PREFERRED EMBODIMENT

no drawings

### DETAILED DESCRIPTION OF THE PREFERRED EMBODIMENT

An artificial masonry piece (10) consists in admixing 1 portion of perlite, by volume, with 7 portions of calcium sulfate (CaSO₄) in solution. Once admixed, the compound is stirred at low speed, approximately 60-100 RPM for about 10 minutes. During stirring, various pigments are added, they are generally metal oxydes, the amount and types of pigments added depends upon the final color desired. The calcium sulfate in solution is readily available commercially and facilitates the manufacturing process since it is already optimally premixed.

Once the stirring is completed, the compound is put into a vacuum chamber in order to remove air bubbles trapped inside. The mixture is taken out of the vacuum chamber and poured into molds to cure. The preferred curing process is done at a temperature set at between 12 C to 25 C, preferably at 17% relative humidity and for about 4 hours.

Method of installation: Since the mansory pieces are mostly made out of calcium sulfate and are lightweight, many types of adhesives can be used, including a standard type 1 tile adhesive, to cover the surface upon which one desires to install the masonry pieces. The material upon which the adhesive is applied can be concrete, cinder blocks, gypsum boards, wood, melamine, which covers just about anything a wall can be made of. A wire mesh is not needed prior to the application of the adhesive.

The masonry pieces are applied to the wall. When a piece is too large for the place it is intended to be, it is cut by simply making a score line with a cutting means such as a knife or saw, even a blunt object like a screwdriver or a key. Once the score line is made, the piece can then be cracked, somewhat like cracking glass or ceramic.

To finish the job, the joints are filled with mortar as is normally done for ordinary brick or stone construction.

### Conclusion as to Inventive Combination

It is thus seen that an artificial piece of masonry as used according to the combination of inventive concepts and details herein set forth, provides novel concepts of a desirable and usefully advantageous installation and procedure, yielding advantages which are and provide special and particular advantages when used as herein set forth.

In summary as to the nature of the overall and advantageous concepts, their novelty and inventive nature is shown by novel features of concept and construction shown here in advantageous combination and by the novel concepts hereof not only being different from all the prior art known, even though other artificial pieces of masonry have been known and used for scores of years, but because the achievement is not what is or has been suggested to those of ordinary skill in the art, especially realistically considering this as a novel combination comprising components which individually are similar in nature to what is well known to most all persons, surely including most of the many technicians and professionals of masonry and related construction trades for a great number of years, throughout the entire world. No prior art component or element has even suggested the modifications of any other prior art to achieve the particulars of the novel concepts of the overall combination here achieved, with the special advantages which the overall combination system provides; and this lack of suggestion by any prior art has been in spite of the long worldwide use of masonry products.

The differences of concept and construction as specified herein yield advantages over the prior art; and the lack of this invention by the prior art, as a prior art combination, has been in spite of this invention's apparent simplicity of the construction once the concepts have been conceived, in spite of the advantages it would have given, and in spite of the availability of all the materials, to all persons of the entire world, and the invention's non-technical and openly-visible nature.

Quite certainly this particular combination of prior art details as here presented in this overall combination has not been suggested by the prior art, this achievement in its particular details and utility being a substantial and advantageous departure from prior art, even though the prior art has had somewhat similar systems for numbers of years. And particularly is the overall difference from the prior art significant when the non-obviousness is viewed by a consideration of the subject matter of this overall device as a whole, as a combination integrally incorporating features different in their combination from the prior art, in contrast to merely separate details themselves, and further in view of the prior art not achieving particular advantages here achieved by this combination.

Accordingly, it will thus be seen from the foregoing description of the invention according to these embodiments, that the present invention provides new and useful concepts of a novel and advantageous system and procedure, possessing and yielding desired advantages and characteristics in formation and use, and accomplishing the intended objects, including those hereinbefore pointed out and others which are inherent in the invention. Modifications and variations may be effected without departing from the scope of the novel concepts of the invention; accordingly, the invention is not limited to the specific embodiments, or form or arrangement of components herein described.

1. An artificial masonry piece cutable by scoring with the use of a blunt instrument or a knife and wherein:
a portion of perlite admixed, by volume, with 7 portions of calcium sulfate (CaSO₄) in solution;
the resulting mixture being stirred;
pigments being added; and
said mixture being poured into molds for curing;
once cured, said artificial masonry piece being cutable by scoring.

2. A method for manufacturing artificial masonry pieces consisting of:
one portion of perlite is admixed, by volume, with 7 portions of calcium sulfate (CaSO₄) in solution and a resulting mixture is stirred;
pigments are added which are metal oxides;
the mixture is poured into molds and set to cure.

3. An artificial masonry piece as in claim 1 wherein:
a curing process is done at a temperature set at between 12 C to 25 C.

4. An artificial masonry piece as in claim 1 wherein:
a curing process is done at 17% relative humidity.

5. An artificial masonry piece as in claim 1 wherein:
a curing duration is 4 hours.

6. An artificial masonry piece as in claim 1 wherein:
air bubbles are extracted from the resulting mixture after stirring is completed.

7. A method for making artificial masonry pieces consisting of:
one portion of perlite is admixed, by volume, with 7 portions of calcium sulfate (CaSO₄) in solution and a resulting mixture is stirred at a speed, of a range set between 60-100 RPM;
the stirring taking between 8 to 12 minutes;
pigments are added which are generally metal oxides;
the mixture is poured into molds and set to cure.

8. A method for making artificial masonry pieces as in claim 7 wherein:
a curing process is done at a temperature set at between 12 C to 25 C.

9. A method for making artificial masonry pieces as in claim 7 wherein:
a curing process is done at 17% relative humidity.

10. A method for making artificial masonry pieces as in claim 7 wherein:
a curing duration is 4 hours.

11. A method for making artificial masonry pieces as in claim 7 wherein:
after stirring is completed, air bubbles are extracted from the mixture;

12. A method for installing artificial masonry pieces resulting from the method of fabrication as described in claim 2
wherein:
an adhesive or bonding agent is applied onto a surface;
masonry pieces are applied to the surface;
the masonry pieces are cut by making a score line with a cutting means and the piece is cracked;
joints are filled with mortar as is normally done for ordinary brick or stone construction.

13. A method for installing artificial masonry pieces resulting from the method of fabrication as described in claim 7 wherein:
an adhesive or bonding agent is applied onto a surface;
masonry pieces are applied to said surface;
said masonry pieces are cut by making a score line with a cutting means and said piece is cracked;
joints are filled with mortar as is normally done for ordinary brick or stone construction.
